(19) United States
(12) Patent Application Publication
(10) Pub. No.: US 2018/0071905 A1
(43) Pub. Date: Mar. 15, 2018

(54) GEAR ADJUSTING DEVICE FOR ELECTRIC IMPACT DRILL

(71) Applicant: Best Select Industrial (SuZhou) Co., Ltd, Suzhou City (CN)

(72) Inventors: Qiang WANG, Suzhou City (CN); Hsi-Jen JEN, Suzhou City (CN); Yi-Tung CHIU, Suzhou City (CN)

(21) Appl. No.: 15/290,670

(22) Filed: Oct. 11, 2016

(30) Foreign Application Priority Data
Sep. 14, 2016 (CN) 201610820974.3

(51) Int. Cl. B25D 16/00

(52) U.S. Cl. CPC B25D 16/006; B25D 2216/0084

(57) ABSTRACT

A gear adjusting device for an electric impact device, comprising a front gearbox housing, a torsional cover rotationally sleeved at the top of the front gearbox housing, a reduction mechanism disposed at the bottom of the front gearbox housing and a tripping structure disposed within the torsional cover. The tripping structure consists of an adjusting screw, a tripping cushion, an adjusting ring and an impact conversion cushion. The adjusting ring can lock the tripping cushion and the impact conversion cushion. The torsional cover and the adjusting ring are provided with corresponding upper bosses and lower bosses, so the torsional cover drives the adjusting ring to rotate during anticlockwise rotation and when the torsional cover rotates clockwise, the adjusting ring does not rotate. Therefore, gear switching can be conducted when the torsional cover is rotated anticlockwise, achieving the effects of short adjustment stroke and quick switching.

### BACKGROUND OF THE INVENTION

### Technical Field

The present invention relates to the technical field of electrical tools, in particular to a gear adjusting device for an electric impact drill.

### Description of Related Art

An electric impact drill is a common electric decorating tool, usually provided with three gear shifts, namely a screw gear, an electric drill gear and an impact gear. The adjustment of the three gear shifts are conducted by regulating and changing the torsional torque and tripping of inner structures in the drills. The most common adjusting method is rotation of a torsional cover. However, during the adjustment process of the existing electric impact drills, the torsional stroke of the torsional cover is too large, so users sometimes fail to obtain accurate adjustment due to insufficient torsional stroke, thereby affecting operation quality and operation speed and bringing potential safety dangers in use.

### BRIEF SUMMARY OF THE INVENTION

The objective of the present invention is to provide a gear adjusting device for an electric impact drill to solve the problem of excessive large gear adjusting torsional stroke of the existing electric impact drill.

A gear adjusting device for an electric impact drill consists of a front gearbox housing, a torsional cover rotationally sleeved at the top of the front gearbox housing, a reduction mechanism disposed at the bottom of the front gearbox housing and a tripping structure disposed within the torsional cover. The tripping structure consists of an adjusting screw in threaded connection with the torsional cover, a tripping cushion, an adjusting ring and an impact conversion cushion. The adjusting screw is connected with a plurality of vertical compression springs. The adjusting screw is connected with one end of each of the plurality of vertical compression springs, and the other end of each of the compression springs is connected with the tripping cushion. The tripping cushion, the adjusting ring and the impact conversion cushion are disposed on the front gearbox housing in turn from the bottom up. A lock structure for locking the impact conversion cushion is disposed at the upper end face of the adjusting ring. A lock structure for locking the tripping cushion is disposed at the lower end face of the adjusting ring. An upper boss is disposed at the upper end of the inner surface of the torsional cover; a corresponding lower boss is disposed on the upper end face of the adjusting ring; and the lower boss is positioned on the right side of the upper boss.

In one of the embodiments, the impact conversion cushion includes a round ring and three poke rods which are uniformly distributed on the circumference of the round ring in a radiative way. Lock grooves, corresponding to the poke rods, are formed at the upper end face of the adjusting ring. The tripping cushion is ring-shaped. The tripping cushion is internally provided with a plurality of limiting projections inwards. Lock grooves, corresponding to the limiting projections, are formed at the lower end face of the adjusting ring. Horizontal lock platforms are formed among the lock grooves. When the adjusting ring locks the tripping cushion or the impact conversion cushion, the lock platforms contact the limiting projections or the poke rods.

In one of the embodiments, a plurality of bosses are disposed at the front end of the front gearbox housing, and the adjusting ring is sleeved below the bosses, so the adjusting ring cannot move up and down.

In one of the embodiments, each boss is formed with a limiting chute which extends along the vertical direction, and the poke rods are embedded in the limiting chutes.

In one of the embodiments, a positioning block is equipped above the adjusting screw; the top end of the positioning block is connected with the torsional cover; a chute is formed at the inner side of the adjusting screw along the vertical direction; a sliding portion matched with the chute is disposed at the lower end of the positioning block; and the adjusting screw is in sliding connection with the sliding portion of the positioning block.

In one of the embodiments, an output shaft penetrates the middle of the front gearbox housing; the bottom of the output shaft is connected with the reduction mechanism; the output shaft is sleeved with an impact structure; the round ring of the impact conversion cushion is sleeved on the output shaft; and the impact structure is disposed below the impact conversion cushion.

In one of the embodiments, a reset torsional spring is connected between the tripping cushion and the adjusting ring.

In conclusion, by using the above technical scheme, the present invention has at least the following technical characteristics and progresses.

1. The torsional cover and the adjusting screw are connected by screw threads. In use, rotating the torsional cover can drive the adjusting screw to move up and down, thereby changing the elastic force of the compression springs and realizing different torsion outputs. Different torsion outputs can be achieved by direct rotation of the torsional cover.

2. The torsional cover and the adjusting ring are provided with corresponding upper bosses and lower bosses, so the torsional cover drives the adjusting ring to rotate during anticlockwise rotation and when the torsional cover rotates clockwise, the adjusting ring does not rotate. Besides, the adjusting ring can switch the locking function of the tripping cushion and the impact conversion cushion during rotation, thereby realizing the switching of the electric drill gear. Therefore, gear switching can be conducted when the torsional cover is rotated anticlockwise, achieving the effects of short adjustment stroke and quick switching.

### BRIEF DESCRIPTION OF THE SEVERAL VIEWS OF THE DRAWINGS

FIG. 1 is a schematic view of the breakdown structure of an embodiment of the present invention.

FIG. 2 is a sectional structural view of an embodiment of the present invention.

FIG. 3 is a structural view of a torsional cover of an embodiment of the present invention.

### DETAILED DESCRIPTION OF THE INVENTION

The present invention is described in further detail in conjunction with the attached drawings and embodiments.

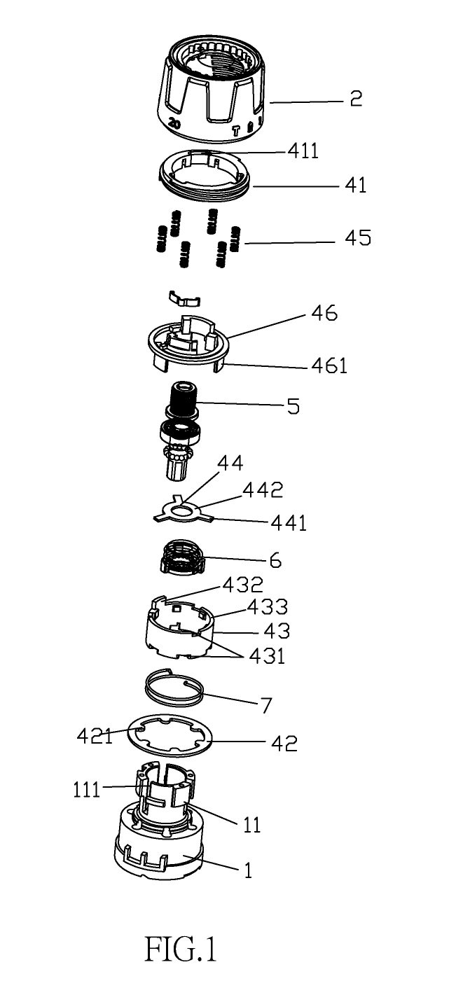

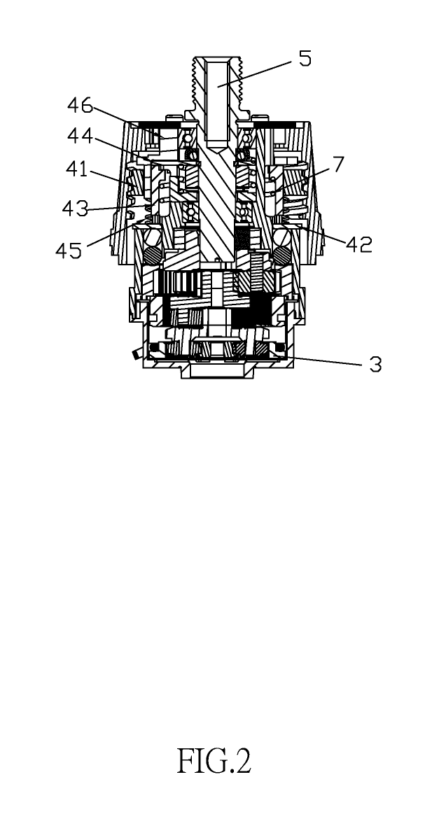

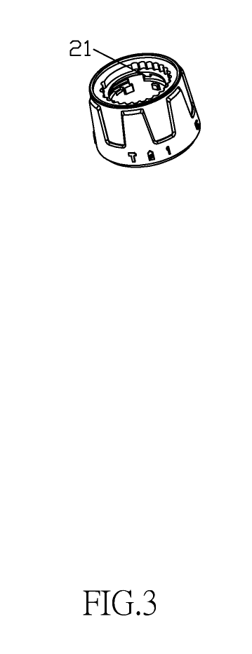

As shown in FIG. 1, FIG. 2 and FIG. 3, a gear adjusting device for an electric impact drill consists of a front gearbox housing 1, a torsional cover 2 rotationally sleeved at the top of the front gearbox housing 1, a reduction mechanism 3 disposed at the bottom of the front gearbox housing 1 and a tripping structure disposed within the torsional cover 2. The tripping structure consists of an adjusting screw 4 in threaded connection with the torsional cover 2, a tripping cushion 42, an adjusting ring 43 and an impact conversion cushion 44. The adjusting screw 41 is connected with a plurality of vertical compression springs 45. The adjusting screw 41 is connected with one end of each of the plurality of vertical compression springs 45, and the other end of each of the compression springs 45 is connected with the tripping cushion 42. The tripping cushion 42, the adjusting ring 43 and the impact conversion cushion 44 are disposed on the front gearbox housing 1 in turn from the bottom up. A lock structure for locking the impact conversion cushion 44 is disposed at the upper end face of the adjusting ring 43. A lock structure for locking the tripping cushion 42 is disposed at the lower end face of the adjusting ring 43. An upper boss 21 is disposed at the upper end of the inner surface of the torsional cover 2; a corresponding lower boss 432 is disposed at the upper end face of the adjusting ring 43; and the lower boss 432 is positioned on the right side of the upper boss 21. The torsional cover 2 rotates to drive the adjusting screw 41 to move up and down. The vertical movement of the adjusting screw 41 changes the compression quantity of the compression springs 45 in connection with the adjusting screw 41. By adjusting the compression quantity of the compression springs 45, the torsional cover 2 outputs different torsions. The lower boss 432 is positioned on the right side of the upper boss 21, so when the torsional cover 2 rotates anticlockwise, the upper boss 21 positioned at the inner surface thereof drives the lower boss 432 to rotate, namely driving the adjusting ring 43 to rotate. During the rotation process, the adjusting ring 43 locks the tripping cushion 42 and the impact conversion cushion 44, thereby presenting different states of the impact electric drill. Therefore, when the gear adjusting device is used for carrying out the adjustment, it is only needed to rotate the torsional cover 2 anticlockwise. In this way, the adjustment stroke is short, mode switching is achieved by one step, and inaccurate adjustment is avoided.

In one of the embodiments, the impact conversion cushion 44 includes a round ring 442 and three poke rods 441 which are uniformly distributed on the circumference of the round ring 442 in a radiative way. Lock grooves 431, corresponding to the poke rods 441, are formed at the upper end face of the adjusting ring 43. The tripping cushion is ring-shaped. The tripping cushion 42 is internally provided with a plurality of limiting projections 421 inwards. Lock grooves 431, corresponding to the limiting projections 421, are formed at the lower end face of the adjusting ring 43. Horizontal lock platforms 433 are formed among the lock grooves 431. When the adjusting ring 43 locks the tripping cushion 42 or the impact conversion cushion 44, the lock platforms 433 contact the limiting projections 421 or the poke rods 441. When the lock grooves 431 contact the limiting projections 421 or the poke rods 441, the adjusting ring is in a non-locked state. The adjustment mechanism is as follows.

When the torsional cover 2 is positioned at a screw gear, the lock grooves 431 at the lower end face of the adjusting ring 43 contact the limiting projections 421 of the tripping cushion 42, while the lock platforms 433 at the upper end face of the adjusting ring 43 contact the poke rods 441 of the impact conversion cushion 44, which means that, at this time, the tripping cushion 42 is not locked, while the impact conversion cushion 44 is locked, and the tripping cushion 42 moves up and down such that the gearbox can trip without impact. When the torsional cover 2 is rotated anticlockwise, the upper boss 21 on the torsional cover 2 drives the lower boss 432 on the adjusting ring 43 to rotate, realizing rotation of the adjusting ring 43. At this time, the lock platforms 433 at the lower end face of the adjusting ring 43 rotate onto the limiting projections 421 of the tripping cushion 42, while the lock platforms 433 at the upper end face of the adjusting ring 43 still contact the poke rods 441. At this time, both tripping cushion 42 and impact conversion cushion 44 are locked, and the torsional cover 2 is positioned at an electric drill gear. If the torsional cover 2 is continuously rotated anticlockwise to drive the adjusting ring 43 to continue to rotate, the lock platforms at the lower end face of the adjusting ring 43 still contact the limiting projections 421 of the tripping cushion 42, and the lock grooves 431 at the upper end face of the adjusting screw 43 contact the poke rods 441. At this time, the tripping cushion 42 is locked, while the impact conversion cover 44 can move up and down in the lock grooves 431, so an impact structure 6 below the impact conversion cushion 44 achieves an impact effect, meaning that the torsional cover 2 is positioned at an impact gear.

In one of the embodiments, a plurality of bosses 11 are disposed at the front end of the front gearbox housing 1, and the adjusting ring 43 is disposed below the bosses 11, so the adjusting ring 43 cannot move up and down. The adjusting ring 43 changes positions of the lock grooves 431 at the upper and lower end faces thereof through rotation, driving the lock platforms 433 to press the tripping cushion 42 and/or the impact conversion cushion 44 to achieve the locking effect. If the adjusting ring 43 moves up and down, the lock platforms 433 cannot press the tripping cushion 42 and/or the impact conversion cushion 44, failing to achieve the locking effect and having the gear adjusting function blocked. Therefore, the arrangement of the bosses 11 can prevent the adjusting ring 43 from moving up and down.

In one of the embodiments, each boss 11 is formed with a limiting chute 111 which extends along the vertical direction, and the poke rods 441 are embedded in the limiting chutes 111. The poke rods 441 are embedded in the limiting chutes 111 so that the impact conversion cushion 44 can move up and down only. When the impact conversion cushion 44 is locked, the electric impact drill is in the screw or electric drill state; when the impact conversion cushion 44 is not locked, the impact conversion cushion 44 can move up and down in the limiting chute 111, and at this time, the electric impact drill is in the impacting state. The adjusting screw 43 is positioned below the bosses 11, and the locking state of the impact conversion cushion 44 is decided by the fixing state of the poke rods 441 made by the adjusting ring 43, so the embodiment of the poke rods 441 in the limiting chute 111 is good for control over the poke rods 441 by the adjusting rods 43.

In one of the embodiments, a positioning block 46 is equipped above the adjusting screw 41; the top end of the positioning block 46 is connected with the torsional cover 2; a chute 411 is formed at the inner side of the adjusting screw 41 along the vertical direction; a sliding portion 461 matched with the chute 411 is disposed at the lower end of the positioning block 46; and the adjusting screw 41 is in sliding connection with the sliding portion 461 of the positioning block 46. The torsional cover 2 is rotated to drive the adjusting screw 41 in connection with the torsional cover 2, and then the adjusting screw 41 moves to adjust the compression springs 45 in connection with the adjusting screw 41, so the torsional cover 2 realizes different torsion outputs according to the compression quantity of the compression springs 45. In order to improve the conversion rate of the rotation energy of the torsional cover 2, the adjusting screw 41 can move only in the vertical direction. The positioning block 46 plays the role of positioning the adjusting screw 41 in the horizontal direction. Due to the connection between the chute 411 and the sliding portion 461, the adjusting screw 41 can only move vertically along the direction in which the sliding portion 461 is disposed. When the torsional cover 2 is rotated to perform adjustment, the rotational torque thereof is directly converted into the vertical journey of the adjusting screw 41, bringing convenience to the adjustment of the torsion, thereby realizing the objective of the quick gear adjustment.

In one of the embodiments, an output shaft 5 penetrates the middle of the front gearbox housing 1; the bottom of the output shaft 5 is connected with the reduction mechanism 3; the output shaft 5 is sleeved with an impact structure 6; the round ring 442 of the impact conversion cushion 44 is sleeved on the output shaft 5; and the impact structure 6 is disposed below the impact conversion cushion 44. When the impact conversion cushion 44 is locked by the adjusting ring 43, the impact structure 6 cannot conduct normal contact and is positioned at the screw gear or electric drill gear. When the impact conversion cushion 44 is not locked by the adjusting ring 43, the impact conversion cushion can axially move up and down, the impact structure 6 can perform normal contact, and at this time, the lower end face of the adjusting ring 43 locks the tripping cushion 42 such that the reduction mechanism 3 cannot trip. Then, the electric impact drill conducts the impacting function.

In one of the embodiments, a reset torsional spring 7 is connected between the tripping cushion 42 and the adjusting ring 43. The adjusting ring 43 automatically resets by the action force of the reset torsional spring 7 to facilitate adjustment to the gear in the next time.

One specific embodiment of the present invention is described in detail above, which does not limit the structural characteristics of the present invention. Changes or modifications made by any skilled in this field on the basis of the present invention shall fall within the patented scope of the present invention.

What is claimed is:

1. A gear adjusting device for an electric impact drill, consisting of a front gearbox housing, a torsional cover rotationally sleeved at the top of the front gearbox housing, a reduction mechanism disposed at the bottom of the front gearbox housing and a tripping structure disposed within the torsional cover; characterized in that the tripping structure consists of an adjusting screw in threaded connection with the torsional cover, a tripping cushion, an adjusting ring and an impact conversion cushion; the adjusting screw is connected with a plurality of vertical compression springs; the adjusting screw is connected with one end of each of the plurality of vertical compression springs, and the other end of each of the compression springs is connected with the tripping cushion; the tripping cushion, the adjusting ring and the impact conversion cushion are disposed on the front gearbox housing in turn from the bottom up; a lock structure for locking the impact conversion cushion is disposed at the upper end face of the adjusting ring; a lock structure for locking the tripping cushion is disposed at the lower end face of the adjusting ring; an upper boss is disposed at the upper end of the inner surface of the torsional cover; a corresponding lower boss is disposed on the upper end face of the adjusting ring; and the lower boss is positioned on the right side of the upper boss.

2. The gear adjusting device for an electric impact drill according to claim 1, wherein the impact conversion cushion comprises a round ring and three poke rods which are uniformly distributed on the circumference of the round ring in a radiative way; lock grooves, corresponding to the poke rods, are formed at the upper end face of the adjusting ring; the tripping cushion is ring-shaped; the tripping cushion is internally provided with a plurality of limiting projections inwards; lock grooves, corresponding to the limiting projections, are formed at the lower end face of the adjusting ring; horizontal lock platforms are formed among the lock grooves; when the adjusting ring locks the tripping cushion or the impact conversion cushion, the lock platforms contact the limiting projections or the poke rods.

3. The gear adjusting device for an electric impact drill according to claim 2, wherein a plurality of bosses are disposed at the front end of the front gearbox housing, and the adjusting ring is sleeved below the bosses, so the adjusting ring cannot move up and down.

4. The gear adjusting device for an electric impact drill according to claim 3, wherein each boss is formed with a limiting chute which extends along the vertical direction, and the poke rods are embedded in the limiting chutes.

5. The gear adjusting device for an electric impact drill according to claim 1, wherein a positioning block is equipped above the adjusting screw; the top end of the positioning block is connected with the torsional cover; a chute is formed at the inner side of the adjusting screw along the vertical direction; a sliding portion matched with the chute is disposed at the lower end of the positioning block; and the adjusting screw is in sliding connection with the sliding portion of the positioning block.

6. The gear adjusting device for an electric impact drill according to claim 2, wherein an output shaft penetrates the middle of the front gearbox housing; the bottom of the output shaft is connected with the reduction mechanism; the output shaft is sleeved with an impact structure; the round ring of the impact conversion cushion is sleeved on the output shaft; and the impact structure is disposed below the impact conversion cushion.

7. The gear adjusting device for an electric impact drill according to claim 1, wherein a reset torsional spring is connected between the tripping cushion and the adjusting ring.

8. The gear adjusting device for an electric impact drill according to claim 2, wherein a reset torsional spring is connected between the tripping cushion and the adjusting ring.

9. The gear adjusting device for an electric impact drill according to claim 3, wherein a reset torsional spring is connected between the tripping cushion and the adjusting ring.

10. The gear adjusting device for an electric impact drill according to claim 4, wherein a reset torsional spring is connected between the tripping cushion and the adjusting ring.

11. The gear adjusting device for an electric impact drill according to claim 5, wherein a reset torsional spring is connected between the tripping cushion and the adjusting ring.

12. The gear adjusting device for an electric impact drill according to claim 6, wherein a reset torsional spring is connected between the tripping cushion and the adjusting ring.
